(19) United States
(12) Patent Application Publication
(10) Pub. No.: US 2023/0377407 A1
(43) Pub. Date: Nov. 23, 2023

(54) PRINTING COST CALCULATION SYSTEM, PRINTING COST CALCULATION METHOD, PRINTING COST CALCULATION APPARATUS, TERMINAL APPARATUS, AND RECORDING MEDIUM

(71) Applicant: Konica Minolta, Inc., Tokyo (JP)

(72) Inventor: Tsumoru Matsuura, Tokyo (JP)

(73) Assignee: Konica Minolta, Inc., Tokyo (JP)

(21) Appl. No.: 18/319,499

(22) Filed: May 18, 2023

(30) Foreign Application Priority Data
May 18, 2022 (JP) 2022-081621

(51) Int. Cl. G07F 17/26; G06Q 30/0283

(52) U.S. Cl. CPC G07F 17/26; G06Q 30/0283

(57) ABSTRACT

A printing cost calculation system includes a terminal apparatus that instructs an image forming apparatus to perform printing and a printing cost calculation apparatus that communicates with the terminal apparatus. The terminal apparatus includes a hardware processor that transmits calculation information necessary for calculating a printing cost including information unique to the image forming apparatus to the printing cost calculation apparatus. The printing cost calculation apparatus includes a hardware processor that calculates the printing cost based on the calculation information transmitted from the terminal apparatus and outputs a calculation result of the printing cost.

### CROSS-REFERENCE TO RELATED APPLICATION

This application claims priority from Japanese Patent Application No. 2022-081621 filed on May 18, 2022, the contents of which are incorporated herein by reference in its entirety.

### BACKGROUND

### 1. Technical Field

The present invention relates to a printing cost calculation system, a printing cost calculation method, and a printing cost calculation apparatus that can calculate a printing cost even in a case where printing is performed by a printer that is not a management target of the printing cost, such as a printer owned by an individual, and further relates to a terminal apparatus and a recording medium to be used in a printing cost calculation system.

### 2. Description of Related Art

In recent years, work from home has become a popular way of working. A personal computer (hereinafter, also referred to as a PC) used in work from home is often provided by the company. However, a printer used for work is often owned by an individual employer and located at home.

In a case where a printer is used at a workplace, printing costs such as toner costs are managed by the company and are a burden on the company. On the other hand, a printer at home is originally purchased for personal use, and the individual employee generally pays for ink. For this reason, when an individually owned printer is used for work from home, the individual employee must bear the cost of ink. In addition, the individual employee may charge the company for the cost after use, but there is a problem of lack of accuracy.

The following technologies are disclosed in Japanese Unexamined Patent Application Publication No. 2018-207344. In response to a print instruction from the user, the image forming apparatus requests a business document determination system to determine whether or not a document to be printed is for business use. The business document determination system determines whether or not the document is for business based on the template, images, and words, and in a case where the document is for business, the document is printed and the company is charged. If it is determined to be private use, a warning is displayed on a display section, and the user is made to select and instruct business use or private use. In contrast to this, assume that it is determined to be business use, and the user selects and instructs business use. In this case, the page is stored in a document storage server, and a manager terminal is notified of the corresponding information.

The following technologies are disclosed in Japanese Unexamined Patent Application Publication No. 2005-111948. Under the control of a control module, a function specifying module specifies a designated function from among a plurality of functions of an image forming apparatus. If the designated function is the “Photo Print function”, a personal identification module identifies a personal ID. A business/private classification module specifies a business/private classification. A time zone determination module determines a time zone. In response to this result, an image reading module reads image data. An image formation instruction module instructs image formation based on the image data. A history recording module records a history of image formation. A charging module charges an individual in the case of private use, and charges a division in other cases.

With the technologies described in Japanese Unexamined Patent Application Publication Nos. 2018-207344 and 2005-111948, it can be determined whether printing is for business use. However, the above-mentioned two publications do not mention that when printing for business use is performed by, for example, an individually owned printer whose cost is not managed, how the cost of printing can be settled.

### SUMMARY

One or more embodiments of the present invention provide a printing cost calculation system, a printing cost calculation method, and a printing cost calculation apparatus that can automatically calculate a printing cost in order to settle a printing cost when using, for example, an individually owned printer whose cost is not managed in work from home or the like and further provide a terminal apparatus and a non-transitory computer readable recording medium storing instructions to be used in such system or method.

The first aspect of the present invention relates to
a printing cost calculation system including a terminal apparatus that instructs an image forming apparatus to perform printing and a printing cost calculation apparatus capable of communicating with the terminal apparatus.

The terminal apparatus includes a hardware processor that transmits calculation information necessary for calculating a printing cost including information unique to the image forming apparatus to the printing cost calculation apparatus.

The printing cost calculation apparatus includes a hardware processor that: calculates a printing cost based on the calculation information transmitted from the terminal apparatus; and outputs a calculation result of the printing cost.

The second aspect of the present invention relates to
a printing cost calculation method executed by a printing cost calculation system including a terminal apparatus that instructs an image forming apparatus to perform printing and a printing cost calculation apparatus capable of communicating with the terminal apparatus.

The printing cost calculation method includes causing the terminal apparatus to transmit calculation information necessary for calculating a printing cost including information unique to the image forming apparatus to the printing cost calculation apparatus, and causing the printing cost calculation apparatus to calculate a printing cost based on the calculation information transmitted from the terminal apparatus and output a calculation result.

The third aspect of the present invention relates to
a printing cost calculation apparatus capable of communicating with a terminal apparatus that instructs an image forming apparatus to perform printing.

The printing cost calculation apparatus includes a hardware processor that:
receives, from the terminal apparatus, calculation information necessary for calculating a printing cost, the calculation information including information unique to the image forming apparatus;
calculates a printing cost based on the calculation information; and
outputs a calculation result of the printing cost.

### BRIEF DESCRIPTION OF THE DRAWINGS

The advantages and features provided by one or more embodiments of the invention will become more fully understood from the detailed description hereinbelow and the appended drawings which are given by way of illustration only, and thus are not intended as a definition of the limits of the present invention:

FIG. 1 is a block diagram illustrating the configuration of a printing cost calculation system according to one or more embodiments of the present invention;

FIG. 2 is a block diagram illustrating the configuration of a terminal apparatus;

FIG. 3 is a flowchart for describing the operation of the terminal apparatus according to the one or more embodiments of the present invention;

FIG. 4 is a flowchart for describing the operation of the printing cost calculation apparatus according to the one or more embodiments of the present invention;

FIG. 5 is a flowchart illustrating the subroutine of printing cost calculation processing in step S15 in FIG. 4;

FIG. 6 is a flowchart illustrating the operation of a terminal apparatus according to one or more embodiments of the present invention;

FIG. 7 is a diagram illustrating a print setting screen of a printer driver displayed on the terminal apparatus;

FIG. 8 is a flowchart illustrating the operation of the printing cost calculation apparatus that determines whether or not to perform printing for business use and determines whether or not to permit payment;

FIG. 9 is a flowchart illustrating another example of the operation in a case where the printing cost calculation apparatus determines whether or not to perform printing for business use and determines whether or not to permit payment;

FIG. 10 is a flowchart illustrating still another example of the operation in a case where the printing cost calculation apparatus determines whether or not to perform printing for business use and determines whether or not to permit payment;

FIG. 11 is a flowchart for describing the operation of a terminal apparatus that receives a determination result as to whether the printing cost calculation apparatus described with reference to FIGS. 8 to 10 is printing for business use;

FIG. 12 is a configuration diagram of a printing cost calculation system according to one or more embodiments of the present invention;

FIG. 13 is a flowchart illustrating the operation of the terminal apparatus in a case of transmitting an employee ID together with calculation information in order to perform settlement of a printing cost;

FIG. 14 is a flowchart illustrating the operation of the printing cost calculation apparatus that has received calculation information and an employee ID from the terminal apparatus;

FIG. 15 is a flowchart illustrating an operation when the settlement function of the printing cost calculation apparatus is used;

FIG. 16 is a flowchart illustrating the operation of the printing cost calculation apparatus according to one or more embodiments of the present invention;

FIG. 17 is a flowchart illustrating the operation of the terminal apparatus according to one or more embodiments of the present invention;

FIG. 18 is a flowchart illustrating the operation of the printing cost calculation apparatus that receives calculation information before and after printing;

FIG. 19 is a flowchart illustrating the operation of a printing cost calculation apparatus according to one or more embodiments of the present invention; and

FIG. 20 is a flowchart illustrating the operation of a printing cost calculation apparatus according to one or more embodiments of the present invention.

### DETAILED DESCRIPTION OF EMBODIMENTS

Hereinafter, embodiments of the present invention will be described with reference to the drawings. However, the scope of the invention is not limited to the disclosed embodiments.

Embodiments of the present invention will be described below with reference to the accompanying drawings.

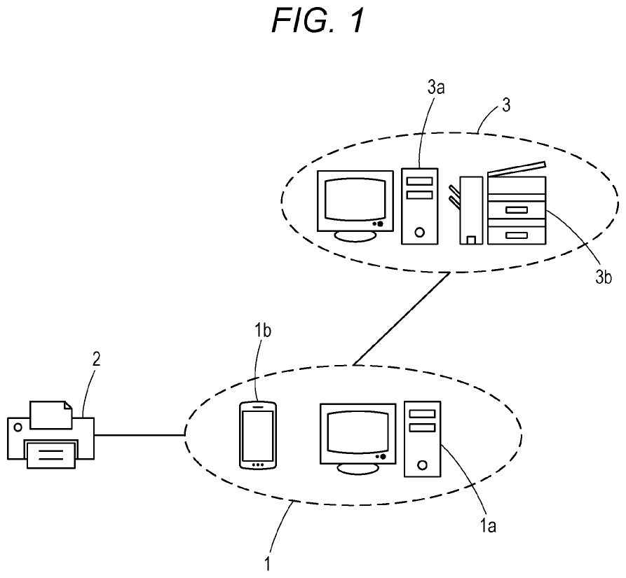

FIG. 1 is a block diagram illustrating the configuration of a printing cost calculation system according to one or more embodiments of the present invention. This printing cost calculation system includes a terminal apparatus 1, an image forming apparatus 2, and a printing cost calculation apparatus 3.

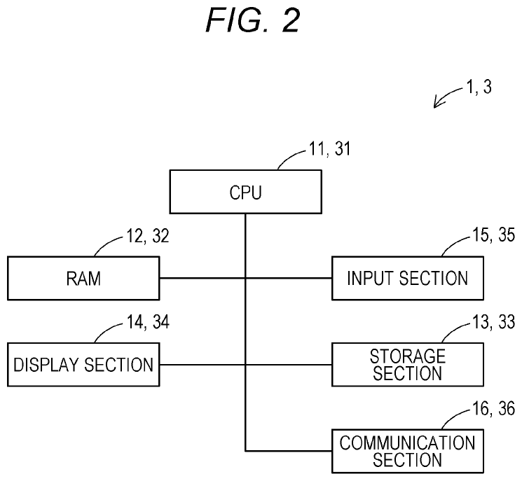

The terminal apparatus 1 is constituted by a PC 1a or a tablet 1b and is used at a home or the like where a printing person (or a user) performs work from home. The terminal apparatus 1 performs operations such as giving a print instruction to the image forming apparatus 2, collecting calculation information for calculating the printing cost of the image forming apparatus 2, and transmitting the calculation information to the printing cost calculation apparatus 3 together with a calculation request. The terminal apparatus 1 may be provided with a cost calculation mode, and the calculation information may be collected and transmitted to the printing cost calculation apparatus 3 only in the cost calculation mode. The configuration of the terminal apparatus 1 is illustrated in the block diagram of FIG. 2.

The terminal apparatus 1 comprises a computer including a CPU 11, a RAM 12, a storage section 13, a display section 14, an input section 15, and a communication section 16 in the example depicted in FIG. 2.

The CPU 11 comprehensively controls the terminal apparatus 1 based on an operating system (also simply referred to as OS), a printer driver for controlling printing of the image forming apparatus 2, an application for collecting and transmitting the above-described information for calculation of printing costs (an application is also simply referred to as an app), and other various apps. Specific contents of control will be described later.

The RAM 12 is a memory that provides a work area when the CPU 11 executes an operation program or instructions.

The storage section 13 is a memory that stores the OS, various applications, and other data.

The display section 14 displays various screens and messages such as an operation screen for the user, a document and an image to be printed, and a calculation result (described later) of a printing cost notified from the printing cost calculation apparatus 3. The display section 14 is configured by a display device such as a liquid crystal.

The input section 15 includes a mouse, a touch panel, and the like used for user operations.

The communication section 16 functions as a communication interface for communicating with the image forming apparatus 2 and the printing cost calculation apparatus 3.

The terminal apparatus 1 is installed with the above-described printer driver for controlling printing of the image forming apparatus 2, so that the image forming apparatus 2 can perform printing in one or more embodiments. More specifically, the user opens a print target file from various applications such as a document creation application on the operation screen of the terminal apparatus 1, selects functions such as paper size, one sided/two sided printing, and color/monochrome using a printer driver, and then issues a print instruction. In addition, as described above, an application for transmitting the calculation information necessary for calculating a printing cost when printing is performed by the image forming apparatus 2 to the printing cost calculation apparatus 3 is also installed in the terminal apparatus 1.

The image forming apparatus 2 is, for example, a printer owned by an individual (or the user) who is performing work from home and is communicable with the terminal apparatus 1 in a wired or wireless manner.

The printing cost calculation apparatus 3 calculates a printing cost based on the calculation information transmitted from the terminal apparatus 1 and outputs the calculation result. The printing cost calculation apparatus 3 includes a PC or a server 3a installed in a company, or an image forming apparatus 3b such as a digital multi-function peripheral (MFP). The printing cost calculation apparatus 3 may be a server (including a cloud server) installed on a hardware located outside the company. The output of the calculation result is not limited but is performed with respect to the terminal apparatus 1 through, for example, a network in order to notify the terminal apparatus 1 of the calculation result. In this case, the terminal apparatus 1 displays the notified calculation result of the printing cost, so that the user can recognize the calculated printing cost.

When the printing cost calculation apparatus 3 is configured by a PC or a server, as illustrated in FIG. 2, the printing cost calculation apparatus 3 is constituted by a computer including a CPU 31, a RAM 32, a storage section 33, a display section 34, an input section 35, a communication interface 36, and the like similarly to the terminal apparatus 1. The functions of these components are the same as those of the terminal apparatus 1 except for the types of apps stored in the storage section 33. An app for causing the printing cost calculation apparatus 3 to calculate a printing cost based on the calculation information received from the terminal apparatus 1 and an app for notifying the terminal apparatus 1 of a calculation result of a printing cost are stored and installed in the printing cost calculation apparatus 3.

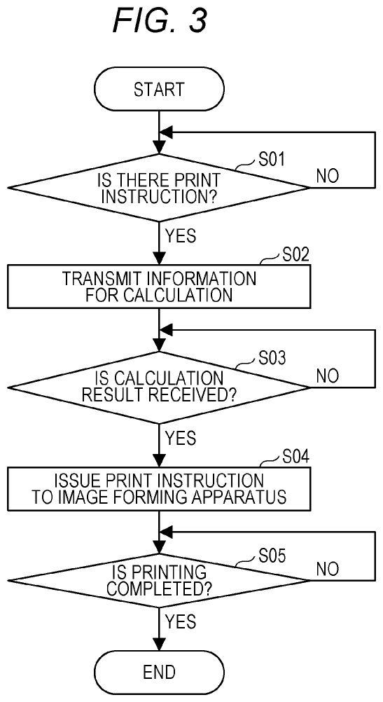

The operation of the printing cost calculation system illustrated in FIG. 1 will be described next. The operations illustrated in the flowcharts of FIG. 3 and subsequent drawings are executed by a hardware processor such as the CPU 11 of the terminal apparatus 1 or the CPU 31 of the printing cost calculation apparatus 3 operating in accordance with the operation program or instructions stored in the storage section 13 or 33 or the like.

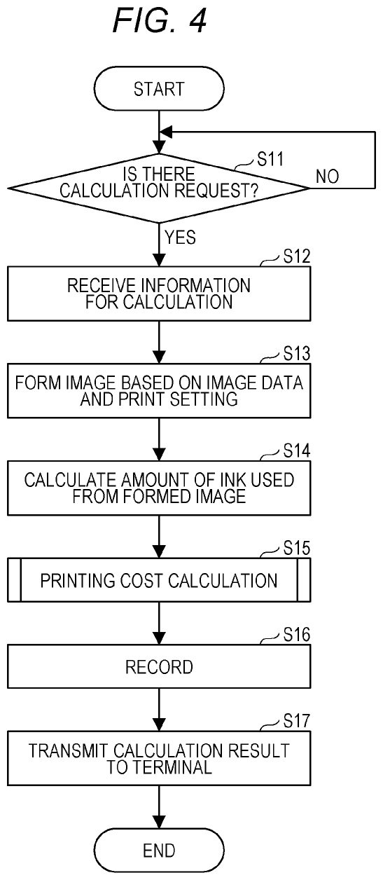

FIGS. 3 and 4 illustrate one or more embodiments of the present invention. FIG. 3 is a flowchart for describing the operation of the terminal apparatus 1. FIG. 4 is a flowchart for describing the operation of the printing cost calculation apparatus 3.

In the flowchart of FIG. 3, in step S01, it is determined whether or not there is a print instruction to the image forming apparatus 2 by the user. If there is no print instruction (NO in step S01), the processing waits until there is a print instruction. If there is a print instruction (YES in step S01), information for calculating a printing cost is collected and transmitted to the printing cost calculation apparatus 3 together with a calculation request in step S02.

The printing cost is mainly a usage charge for consumables such as paper and ink (including toner). In particular, the proportion of the usage charge for the ink is large. These consumables, in particular, ink, vary depending on the type of the image forming apparatus 2. Therefore, the information for calculation of a printing cost includes information unique to the image forming apparatus 2 that can specify a unit price of a consumable to be used, in particular, an ink unit price. The information unique to the image forming apparatus 2 may be the unit price information itself of the consumables or may be product information of the image forming apparatus 2 and/or product information of the consumables used in the image forming apparatus 2. The product information of the image forming apparatus 2 or the consumable is, for example, the name, type, product number, or the like of the image forming apparatus 2 or the consumable.

Since the amount of ink used also varies depending on the image data to be printed, the image data to be printed may be included in the information for calculating a printing cost. Furthermore, the printing cost calculation information may include print settings that affect the usage amount of consumables. The print settings include, for example, the designation of color printing or monochrome printing, settings related to an enlargement ratio such as a 2in1 that combines two pages into one sheet, a sheet size, the number of sheets, and the like.

After the transmission of the printing cost calculation information, it is checked in step S03 whether a calculation result of the printing cost has been received from the printing cost calculation apparatus 3. If the result has not been received (NO in step S03), the processing waits until the result is received. When the result is received (YES in step S03), an instruction to perform printing is given to the image forming apparatus 2 in step S04, and the completion of printing is awaited in step S05 (NO in step S05). When printing is completed (YES in step S05), the processing ends.

Note that the print instruction in step S04 may be issued based on an input of the user. Further, the image forming apparatus 2 may be instructed to perform printing based on the input of the user without waiting for the reception of the calculation result in step S03.

In the flowchart of FIG. 4 illustrating the operation of the printing cost calculation apparatus 3, it is determined in step S11 whether or not there is a calculation request from the terminal apparatus 1. If there is no calculation request (NO in step S11), the processing waits until there is a calculation request. If there is a calculation request (YES in step S11), the calculation information from the terminal apparatus 1 is received in step S12. The printing cost calculation apparatus 3 has an image processing function. In step S13, an image is virtually formed on the image processing function in accordance with the image data and the print setting included in the calculation information.

Next, in step S14, the amount of ink used is calculated from the formed image. In step S15, a printing cost calculation processing is performed based on the calculated amount of ink used, the number of sheets, and the like, and a printing cost is calculated. The printing cost calculation processing will be described later.

Next, in step S16, the calculated printing cost is output to the storage section 33. The calculated printing cost is recorded in the storage section 33 in association with, for example, the user who has performed printing.

Thereafter, in step S17, the calculation result of the printing cost is transmitted (output) to the terminal apparatus 1.

The terminal apparatus 1 displays the notified calculation result of the printing cost on the display section 14. With this display, the user can recognize the printing cost.

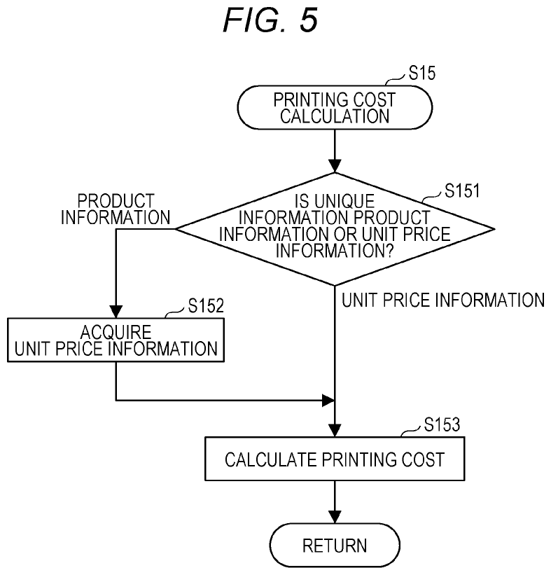

FIG. 5 illustrates a subroutine of the printing cost calculation processing in step S15.

In step S151, it is determined whether the information unique to the image forming apparatus 2 included in the calculation information from the terminal apparatus 1 is product information of the image forming apparatus 2 or a consumable or the unit price information of the consumable. In the case of product information, after unit price information of consumables such as ink and paper is acquired in step S152, the processing proceeds to step S153. In the case of the unit price information of the consumable, the processing directly proceeds to step S153.

After the printing cost is calculated using the unit price information in step S153, the processing returns to the flowchart of FIG. 4.

The acquisition of the unit price information of the consumable in step S152 may be performed by, for example, specifying a manufacturer from product information such as name of the image forming apparatus 2 or the consumable and acquiring the unit price information from a homepage of the manufacturer. Alternatively, a table in which the product information of the image forming apparatus 2 and the consumables and the unit price information of the consumables such as ink are associated with each other may be held in the printing cost calculation apparatus 3, and the unit price information of the consumables may be acquired with reference to the table.

As described above, in some embodiments, the terminal apparatus 1 that instructs the image forming apparatus 2 to perform printing transmits, to the printing cost calculation apparatus 3, calculation information including, for example, the product information of the image forming apparatus 2 and the consumables or the unit price information of the consumables, which is information unique to the image forming apparatus 2 necessary for the calculation of the cost of printing by the image forming apparatus 2. The printing cost calculation apparatus 3 that has received the calculation information calculates the printing cost on the basis of the calculation information and notifies the terminal apparatus 1 of the calculation result. Therefore, even when the image forming apparatus 2 that performs printing, such as work from home, is owned by, for example, an individual (or the user), the printing cost can be calculated by the printing cost calculation apparatus 3. The user can recognize the calculated printing cost (payment amount).

In addition, since the calculation information includes the information unique to the image forming apparatus 2, it is possible to calculate the printing cost with high accuracy for various types of image forming apparatuses 2.

In some embodiments, the calculation information is transmitted to the printing cost calculation apparatus 3 before printing. In other embodiments, the transmission of the calculation information may be performed during printing by the image forming apparatus 2 or may be performed after printing. In a case where the calculation information is transmitted after printing, the calculation information may be information collected before printing or information collected after printing. In the case of the calculation information collected after printing, even if the printing is different from the printing scheduled before the printing due to a trouble such as a paper jam, information on the amount of ink actually used for the printing, the number of sheets, and the like is transmitted to the printing cost calculation apparatus 3.

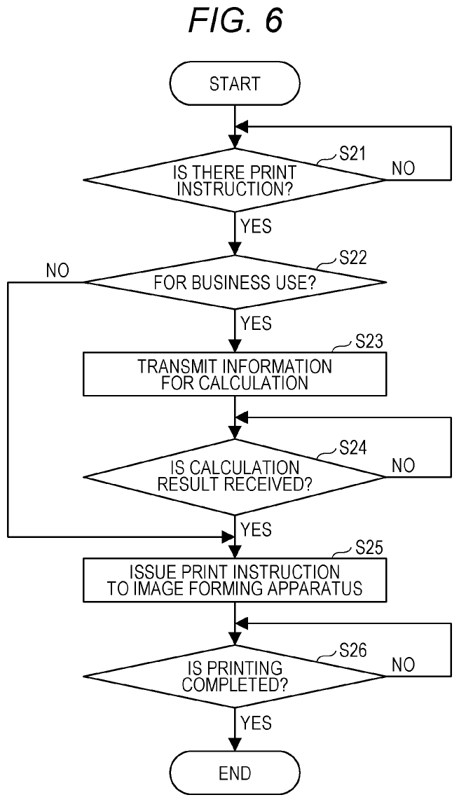

FIG. 6 is a flowchart illustrating the operation of a terminal apparatus 1 according to one or more embodiments of the present invention. The terminal apparatus 1 has a function of determining whether or not to charge the user for the printing cost by determining whether or not printing by the image forming apparatus 2 is for business use.

In step S21, it is determined whether or not there is a print instruction to the image forming apparatus 2 by the user. If there is no print instruction (NO in step S21), the processing waits until there is a print instruction. If there is a print instruction (YES in step S21), it is determined in step S22 whether or not the printing is for business use. The determination of whether or not the printing is for business use will be described later.

If the printing is for business use (YES in step S22), information for calculating a printing cost is collected and transmitted to the printing cost calculation apparatus 3 together with a calculation request in step S23. That is, cost charging is done. Next, in step S24, it is checked whether or not the calculation result of the printing cost is received from the printing cost calculation apparatus 3. If the result has not been received (NO in step S24), the processing waits until the result is received. If the result is received (YES in step S24), the processing proceeds to step S25.

When the printing is not for business use in step S22 (NO in step S22), the processing proceeds to step S25 without transmission of the calculation information (without being charged).

In step S25, the image forming apparatus 2 is instructed to print. The processing waits for the completion of printing in step S26 (NO in step S26). If the printing is completed (YES in step S26), the processing ends.

Note that the print instruction in step S25 may be issued based on an input of the user. Further, the image forming apparatus 2 may be instructed to perform printing based on an input of the user without waiting for the reception of the calculation result in step S24.

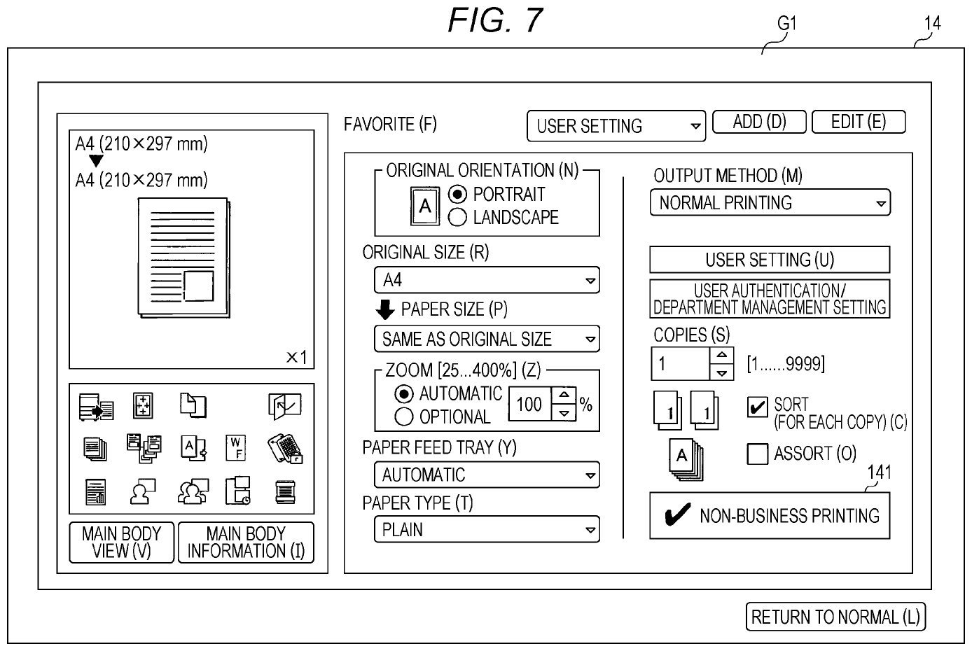

As one of the methods for determining whether or not printing is for business use in step S22, a method of allowing the user to declare business use can be exemplified. More specifically, as illustrated in FIG. 7, when a “non-business printing” button 141 is displayed on a print setting screen G1 for the printer driver which is displayed on the display section 14 of the terminal apparatus 1 and the “non-business printing” button 141 is turned on (checked), it is determined that the printer is used outside of business. When it is not checked, it is determined that the printing is for business use. In this method, it is possible to respect the user's selection.

Another method for determining whether or not printing is for business use includes a method in which the terminal apparatus 1 analyzes image data to be printed and determines whether printing is for business use. More specifically, the terminal apparatus 1 checks whether the image data includes a pre-registered character, pattern, watermark, or the like indicating a business use. If the data has such information, it may be determined that the printing is for business use. Alternatively, printing may be determined to be for business use based on whether a character such as a company name is present in a header or a footer or based on a transmission destination or a reception destination of e-mail in a case of printing an e-mail document.

Still another method for determining whether or not printing is for business use includes a method in which the terminal apparatus 1 checks the attached information of a print target file and determines whether or not the printing is for business use. Examples of the attached information include a file name, a file storage location, a file owner, and a uniform resource locator (URL) in the case of printing a web page. For example, when the file name relates to a business assignment (or work assignment) or the file storage location is an in-house server, it is determined that the file is used for business.

In addition, as still another method of determining whether or not printing is for business use, the determination may be made based on the information of the current time at which the user intends to perform printing. For example, if the current time is within the business hours, it is determined that the printing is for business use.

As described above, in the embodiments illustrated in FIG. 6, it is determined whether or not the terminal apparatus 1 performs printing for business use, and the information for the calculation of a printing cost is transmitted to the printing cost calculation apparatus 3 only when the printing is for business use. This prevents fraudulent charging when the printing is not for business use.

Although the terminal apparatus 1 determines whether or not printing is for business use in the embodiments described with reference to FIG. 6, embodiments in which the printing cost calculation apparatus 3 performs such determination may be employed.

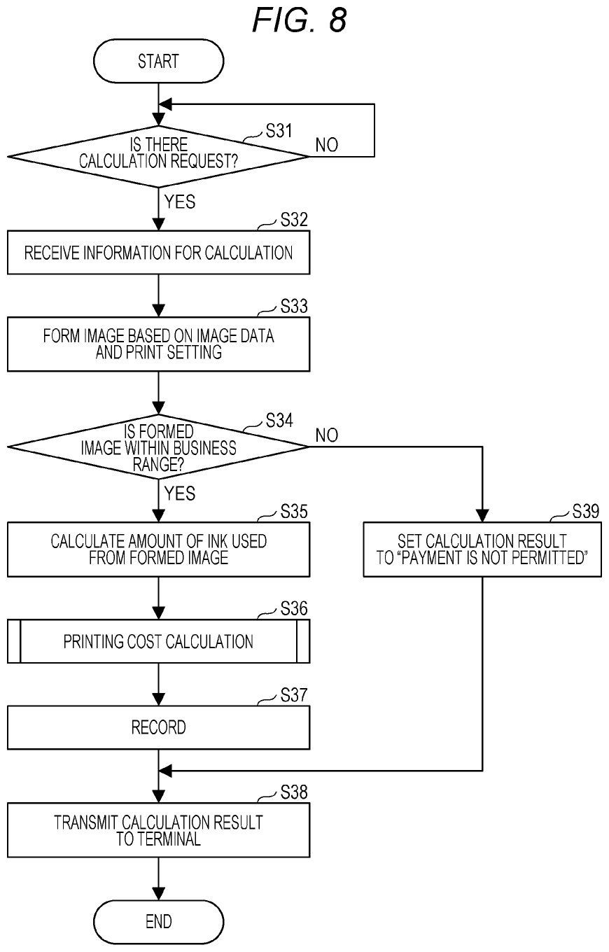

FIG. 8 is a flowchart illustrating the operation of the printing cost calculation apparatus 3 that determines whether or not to perform printing for business use and determines whether or not to permit payment. In the example in FIG. 8, whether or not printing is for business use is determined based on a file (image data) to be printed.

In step S31, it is determined whether or not there is a calculation request from the terminal apparatus 1. If there is no calculation request (NO in step S31), the processing waits until there is a calculation request. When there is a calculation request (YES in step S31), the calculation information from the terminal apparatus 1 is received in step S32, and an image is virtually formed on the image processing function in accordance with the image data and the print setting included in the calculation information in step S33.

Next, in step S34, it is determined whether or not the formed image is within the business range, that is, whether or not the image is used for business. Whether or not the image is within the business range is determined by checking whether or not the image has a pre-registered character, pattern, watermark, or the like indicating that the image is within the business range. If the image includes such information, it is determined that the image is within the business range. Alternatively, whether the printing is for business use may be determined based on whether a character such as a company name is present in a header or a footer or based on a transmission destination or a reception destination of e-mail.

In a case where the image is within the business range in step S34 (YES in step S34), the payment is permitted in step S35, the amount of ink used is calculated from the formed image, and in step S36, printing cost calculation processing is performed based on the calculated amount of ink used, the number of sheets of paper, and the like to calculate a printing cost. The printing cost calculation processing is the same as the processing in step S15 shown in the flowchart of FIG. 4.

Next, in step S37, the calculated printing cost is recorded in association with, for example, the user who performed printing, and then the processing proceeds to step S38.

If the image is not within the business range in step S34 (NO in step S34), the calculation result is set as “payment is not permitted” in step S39, and the processing proceeds to step S38.

In step S38, in a case where payment is permitted, the calculated printing cost is notified to the terminal apparatus 1, whereas in a case of “payment is not permitted”, the corresponding information is notified to the terminal apparatus 1.

The terminal apparatus 1 displays the notified calculation result of the printing cost on the display section 14. This display allows the user to recognize the printing cost for which payment is permitted or the information indicating that payment is not permitted.

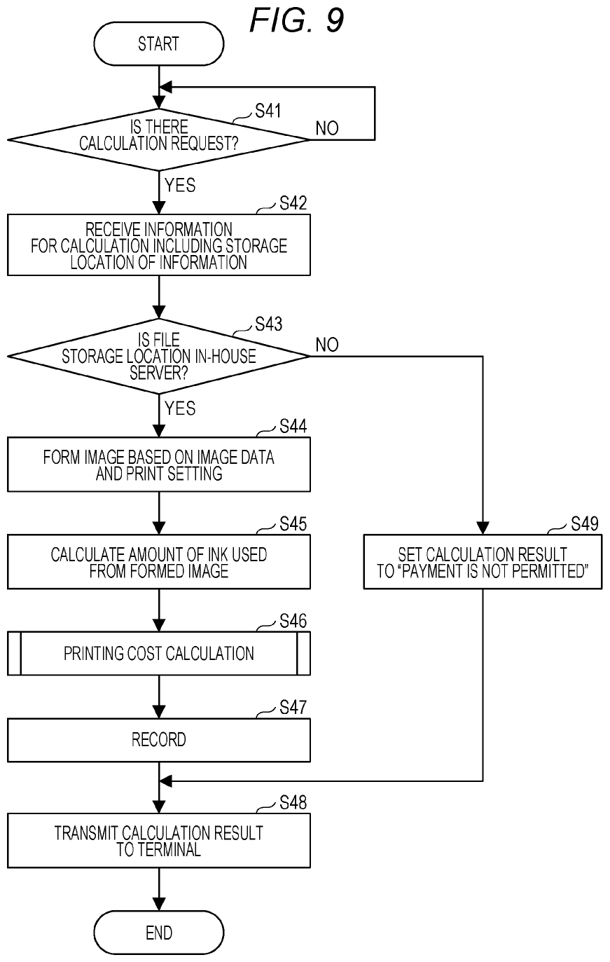

FIG. 9 is a flowchart illustrating another example of the operation in a case where the printing cost calculation apparatus 3 determines whether or not to perform printing for business use and determines whether or not to permit payment. In the example of FIG. 9, whether or not the printing is for business use is determined based on the file storage location which is one of the attached information of the print target file.

In step S41, it is determined whether or not there is a calculation request from the terminal apparatus 1. If there is no calculation request (NO in step S41), the processing waits until there is a calculation request. When there is a calculation request (YES in step S41), information for calculation including the information of the storage location of the print target file is received from the terminal apparatus 1 in step S42, and it is determined in step S43 whether or not the storage location of the print target file is the in-house server. In addition, in a case where the print target file name as attached information is used for the determination, if the file name is related to a business assignment, it is determined that the assignment is within the business range. Other attached information that can be used for the determination can include a file owner, an URL in the case of web page printing and the like.

If the storage location of the print target file is the in-house server in step S43 (YES in step S43), it is assumed that payment is permitted in step S44, and an image is virtually formed on the image processing function in accordance with the image data and the print settings included in the calculation information.

In step S45, the amount of ink used is calculated from the formed image, and then in step S46, printing cost calculation processing is performed based on the calculated amount of ink used, the number of sheets of paper, and the like to calculate a printing cost. The printing cost calculation processing is the same as the processing in step S15 shown in the flowchart of FIG. 4.

Next, in step S47, the calculated printing cost is recorded in association with the user who performed printing, and then the processing proceeds to step S48.

If the storage destination of the print target file is not the in-house server in step S43 (NO in step S43), the calculation result is set as “payment is not permitted” in step S49, and the processing proceeds to step S48.

In step S48, the terminal apparatus 1 is notified of the calculation result, i.e., the calculated printing cost, if payment is permitted. In a case of “payment is not permitted”, the terminal apparatus 1 is notified of the corresponding information.

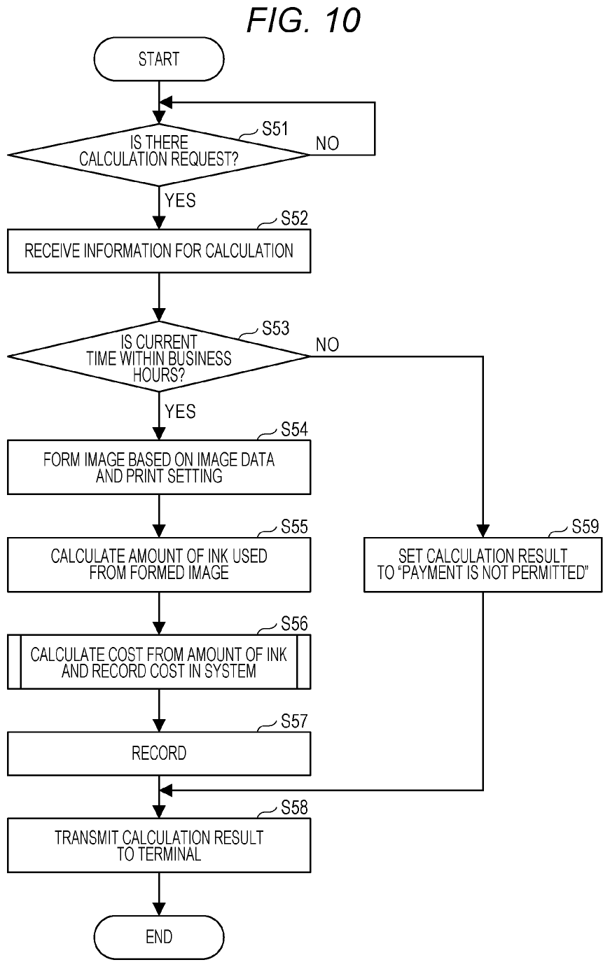

FIG. 10 is a flowchart illustrating still another example of the operation in a case where the printing cost calculation apparatus 3 determines whether or not to perform printing for business use and determines whether or not to permit payment. In the example of FIG. 10, it is determined whether or not the printing is for business use based on time information.

In step S51, it is determined whether or not there is a calculation request from the terminal apparatus 1. If there is no calculation request (NO in step S51), the processing waits until there is a calculation request. In a case where there is a calculation request (YES in step S51), after calculation information is received from the terminal apparatus 1 in step S52, it is determined whether or not the current time is within the business hours in step S53. In a case where the business hours differ for each employee, the attendance information for each employee may be referred to.

If the current time is within the business hours (YES in step S53), the processing in steps S54 to S58 is performed. If the current time is not within the business hours (NO in step S53), the payment is set to “not permitted” in step S59, and the processing proceeds to step S58.

Note that the processing of steps S54 to S58 illustrated in FIG. 10 is the same as the processing in steps S44 to S48 in FIG. 9, and hence a description thereof is omitted.

As for the printing cost calculation apparatus 3 whose operation has been described with reference to the flowcharts of FIGS. 8 to 10, since the printing cost calculation apparatus 3 determines whether or not printing is for business use, the terminal apparatus 1 need not determine whether or not printing is for business use, and it is not necessary to provide a function of determining whether or not printing is for business use in each terminal apparatus 1.

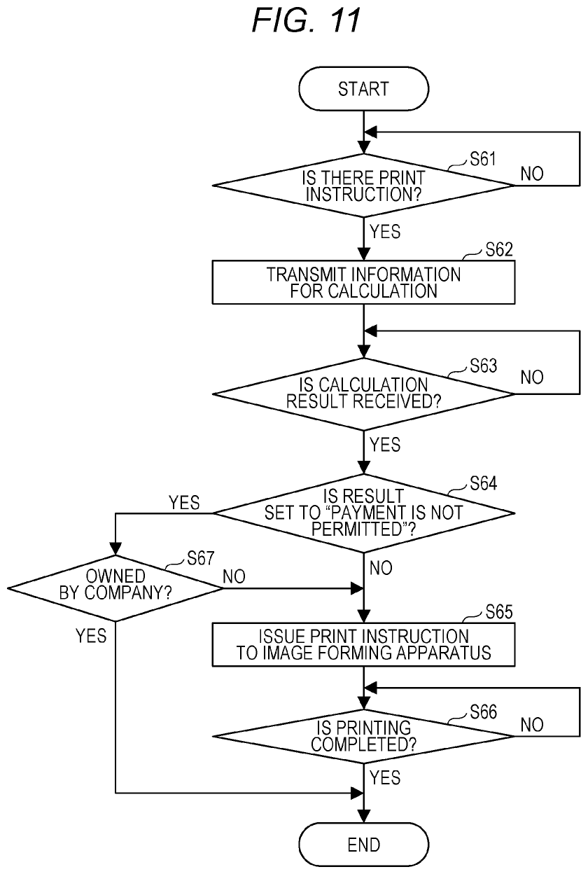

FIG. 11 is a flowchart for describing the operation of the terminal apparatus 1 that has received a determination result as to whether printing is for business use. In this example, different processes are performed depending on whether the terminal apparatus 1 is owned by an individual or a company.

In step S61, it is determined whether or not there is a print instruction to the image forming apparatus 2 by the user. If there is no print instruction (NO in step S61), the processing waits until there is a print instruction. If there is a print instruction (YES in step S61), information for calculating a printing cost is collected and transmitted to the printing cost calculation apparatus 3 together with a calculation request in step S62.

Next, in step S63, it is checked whether or not the calculation result of the printing cost is received from the printing cost calculation apparatus 3. If the result has not been received (NO in step S63), the processing waits until the result is received. If the result is received (YES in step S63), it is determined in step S64 whether or not the result from the printing cost calculation apparatus 3 is “payment is not permitted”. If it is determined that the result is not “payment is not permitted” (NO in step S64), the image forming apparatus 2 is instructed to perform printing in step S65, and the processing is terminated after waiting for the completion of printing in step S66.

In contrast to this, if it is determined in step S64 that the result is “payment is not permitted” (YES in step S64), it is checked in step S67 whether or not the terminal apparatus 1 is owned by the company (lent to the user) based on the information stored in the terminal apparatus 1. If the terminal apparatus is not owned by the company (NO in step S67), the processing proceeds to step S65 to instruct the image forming apparatus 2 to perform printing. If the terminal apparatus is owned by the company (YES in step S67), the processing is terminated in order to prohibit printing other than business.

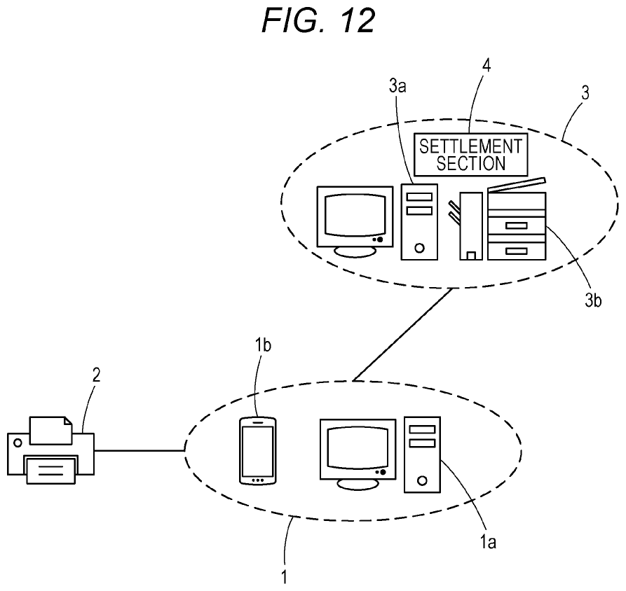

FIG. 12 is a configuration diagram of a printing cost calculation system according to other embodiments of the present invention. This printing cost calculation system includes, in addition to the terminal apparatus 1, the image forming apparatus 2, and the printing cost calculation apparatus 3 in the printing cost calculation system illustrated in FIG. 1, a settlement section (i.e., a cost settlement device) 4 for paying the printing cost calculated by the printing cost calculation apparatus 3 to the user. The settlement section 4 may be configured by a PC, a server, or the like separate from the printing cost calculation apparatus 3. Alternatively, the printing cost calculation apparatus 3 may have the function of the settlement section 4. In such embodiments, the printing cost calculation apparatus 3 will be described as having the function of the settlement section 4.

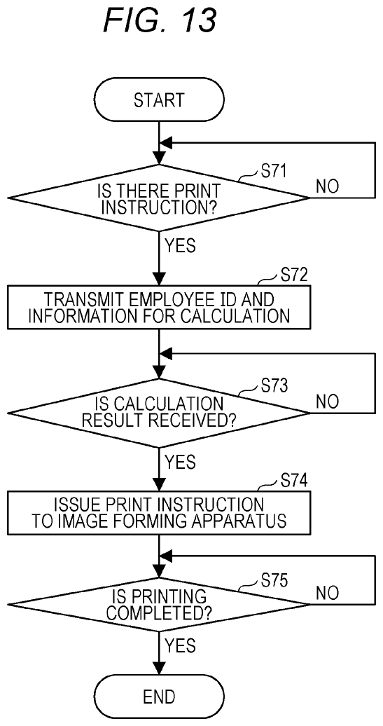

FIG. 13 is a flowchart illustrating the operation of the terminal apparatus 1. The terminal apparatus 1 transmits an employee ID together with calculation information for the settlement of the printing cost.

In step S71, it is determined whether or not there is a print instruction to the image forming apparatus 2 by the user. If there is no print instruction (NO in step S71), the processing waits until there is a print instruction. If there is a print instruction (YES in step S71), an identification symbol indicating an employee (employee ID) and information for calculating a printing cost are collected in step S72. The collected information is transmitted to the printing cost calculation apparatus 3 together with a calculation request.

Next, in step S73, it is checked whether or not the calculation result of the printing cost is received. If the result has not been received (NO in step S73), the processing waits until the result is received. If the result is received (YES in step S73), the image forming apparatus 2 is instructed to perform printing in step S74, and the processing is ended after waiting for the completion of printing in step S75.

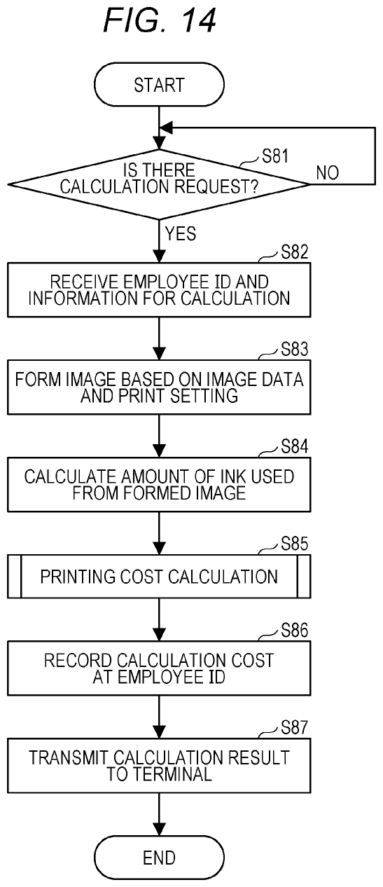

FIG. 14 is a flowchart illustrating the operation of the printing cost calculation apparatus 3 that has received calculation information and an employee ID from the terminal apparatus 1.

In step S81, it is determined whether or not there is a calculation request from the terminal apparatus 1. If there is no calculation request (NO in step S81), the processing waits until there is a calculation request. When there is a calculation request (YES in step S81), the employee ID and the calculation information from the terminal apparatus 1 are received in step S82. Thereafter, in step S83, an image is virtually formed on the image processing function in accordance with the image data and the print setting included in the calculation information.

Next, in step S84, the amount of ink used is calculated from the formed image. In step S85, a printing cost calculation processing is performed based on the calculated amount of ink used, the number of sheets, and the like, and a printing cost is calculated. This printing cost calculation processing is the same as the printing cost calculation processing in step S15 in the flowchart of FIG. 4, and hence a description thereof is omitted.

Then, in step S86, the calculated printing cost is recorded in association with the employee ID. Thereafter, in step S87, the calculation result of the printing cost is transmitted to the terminal apparatus 1.

When the settlement section 4 is an external apparatus different from the printing cost calculation apparatus 3, the printing cost calculated by the printing cost calculation apparatus 3 and the employee ID may be output to the settlement section 4, and the settlement section 4 may store the printing cost in association with the employee ID.

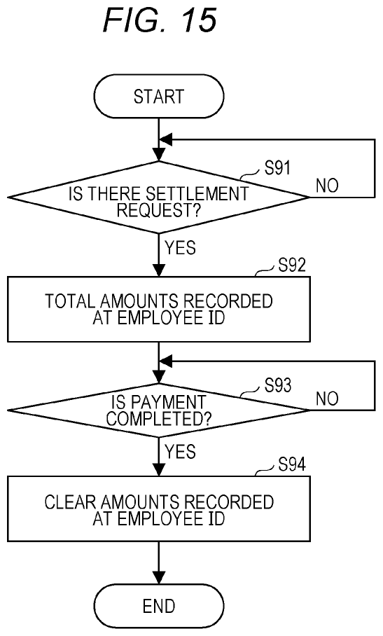

FIG. 15 is a flowchart illustrating an operation when the settlement function of the printing cost calculation apparatus 3 is used.

In step S91, it is determined whether or not there is a settlement request. If there is no settlement request (NO in step S91), the processing waits for a settlement request. If there is a settlement request (YES in step S91), the amounts recorded at the employee ID corresponding to the employee who has made the settlement request are totaled in step S92. Next, in step S93, the processing waits for the completion of payment to an employee account or the like (NO in step S93).

When the payment is completed (YES in step S93), the amount recorded at the employee ID is cleared in step S94.

In this way, it is possible to settle the printing cost in a case where printing is performed by the individually owned image forming apparatus 2 at work from home or the like.

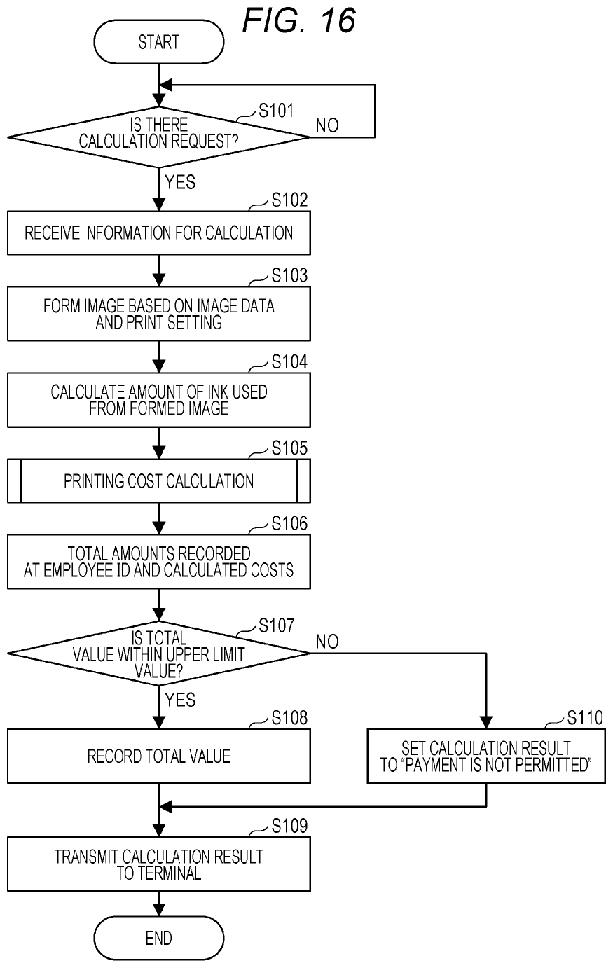

FIG. 16 is a flowchart illustrating the operation of a printing cost calculation apparatus 3 according to other embodiments of the present invention. In such embodiments, an upper limit value is allocated in advance for the payment amount, for example, on a monthly or daily basis for each user who performs printing, and payment is not permitted when the upper limit value is exceeded.

In step S101, it is determined whether or not there is a calculation request from the terminal apparatus 1. If there is no calculation request (NO in step S101), the processing waits until there is a calculation request. When there is a calculation request (YES in step S101), the employee ID and the calculation information from the terminal apparatus 1 are received in step S102, and an image is virtually formed on the image processing function in accordance with the image data and the print setting included in the calculation information in step S103.

Next, in step S104, the amount of ink used is calculated from the formed image. In step S105, a printing cost calculation processing is performed based on the calculated amount of ink used, the number of sheets, and the like, and a printing cost is calculated. This printing cost calculation processing is the same as the printing cost calculation processing in step S15 in the flowchart of FIG. 4.

Next, in step S106, the total amount (printing cost) recorded at the employee ID and the calculated cost are summed up. In step S107, it is determined whether the total value is within the upper limit value allocated in advance for the user. If the total value is within the upper limit value (YES in step S107), the total value is recorded in association with the employee ID in step S108, and the processing proceeds to step S109. If the total value is not within the upper limit value (NO in step S107), the calculation result is set as “payment is not permitted” in step S110, and the processing proceeds to step S109.

In step S109, the calculation result, that is, the calculated printing cost or the calculation result of “payment is not permitted” is transmitted to the terminal apparatus 1.

In this way, the fixed upper limit value limits payments to the user, and thus it is possible to suppress an increase in printing costs.

It should be noted that the upper limit value of the payment amount may be allocated in advance for each user. An upper limit value may be allocated in advance for each group such as an organization to which the user belongs.

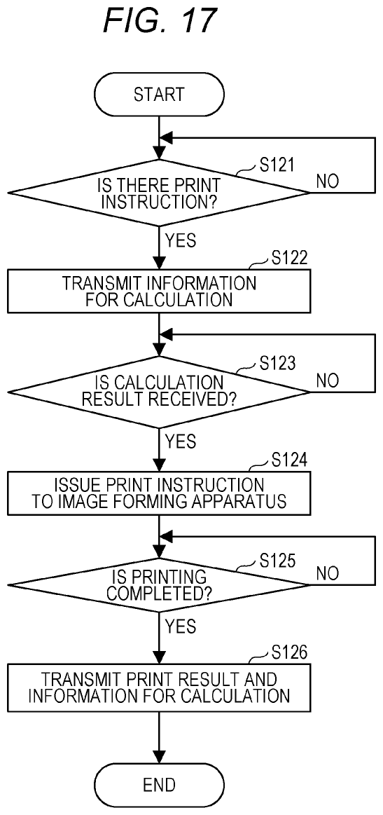

FIG. 17 is a flowchart illustrating the operation of the terminal apparatus 1 according to other embodiments of the present invention. In such embodiments, a printing cost is calculated from the calculation information before and after printing by the image forming apparatus 2. When there is a difference between the calculated printing costs, the printing cost calculated based on the calculation information before printing, which is the previous calculation cost, is updated.

In step S121, it is determined whether or not there is a print instruction to the image forming apparatus 2 by the user. If there is no print instruction (NO in step S121), the processing waits until there is a print instruction. If there is a print instruction (YES in step S121), information for calculating a printing cost is collected and transmitted to the printing cost calculation apparatus 3 together with a calculation request in step S122.

Next, in step S123, it is checked whether or not the calculation result of the printing cost is received from the printing cost calculation apparatus 3. If the result has not been received (NO in step S123), the processing waits until the result is received. If the result is received (YES in step S123), the image forming apparatus 2 is instructed to perform printing in step S124, and the processing waits for the completion of printing in step S125 (NO in step S125).

If the printing is completed (YES in step S125), a print result indicating the presence or absence of an error such as a paper jam and calculation information are transmitted to the printing cost calculation apparatus 3 in step S126. The information for calculation includes the actual number of printed sheets and information unique to the image forming apparatus 2.

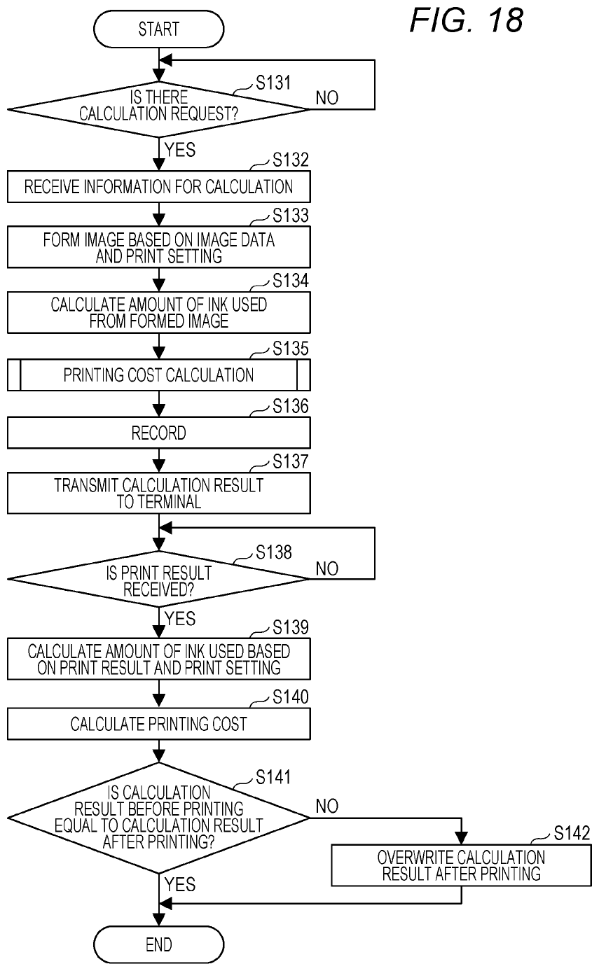

FIG. 18 is a flowchart illustrating the operation of the printing cost calculation apparatus that receives calculation information 3 before and after printing.

In step S131, it is determined whether or not there is a calculation request from the terminal apparatus 1. If there is no calculation request (NO in step S131), the processing waits until there is a calculation request. If there is a calculation request (YES in step S131), the calculation information from the terminal apparatus 1 is received in step S132. In step S133, an image is virtually formed on the image processing function in accordance with the image data and the print setting included in the calculation information.

Next, in step S134, the amount of ink used is calculated from the formed image. In step S135, a printing cost calculation processing is performed based on the calculated amount of ink used, the number of sheets, and the like, and a printing cost is calculated. This printing cost calculation processing is the same as the printing cost calculation processing in step S15 in the flowchart of FIG. 4.

In step S136, the printing cost is recorded in association with the user. In step S137, the calculation result is transmitted to the terminal apparatus 1.

Thereafter, in step S138, the processing waits for the reception of a printing result and calculation information (NO in step S138). If a printing result and calculation information are received (YES in step S138), the amount of ink used is calculated from the formed image in step S139. In step S140, a printing cost is calculated based on the calculated amount of ink used, the number of sheets, and the like, and the processing proceeds to step S141.

In step S141, the calculation result before the printing is compared with the calculation result after the printing, and it is checked whether the results are the same or identical, that is, the printing costs are the same. If they are the same (YES in step S141), no additional step may be necessary in some embodiments. If they are not the same (NO in step S141), the calculation result after the printing is overwritten and recorded in step S142. In a case where the printing costs are different, the calculation result after the printing may be notified to the terminal apparatus 1.

As described above, printing costs may be calculated before and after printing by the image forming apparatus 2. If the printing costs before and after printing are different, the calculation result may be corrected based on actual printing. Therefore, even if a paper jam occurs or printing is cancelled in the middle, it is possible to calculate a printing cost with high accuracy.

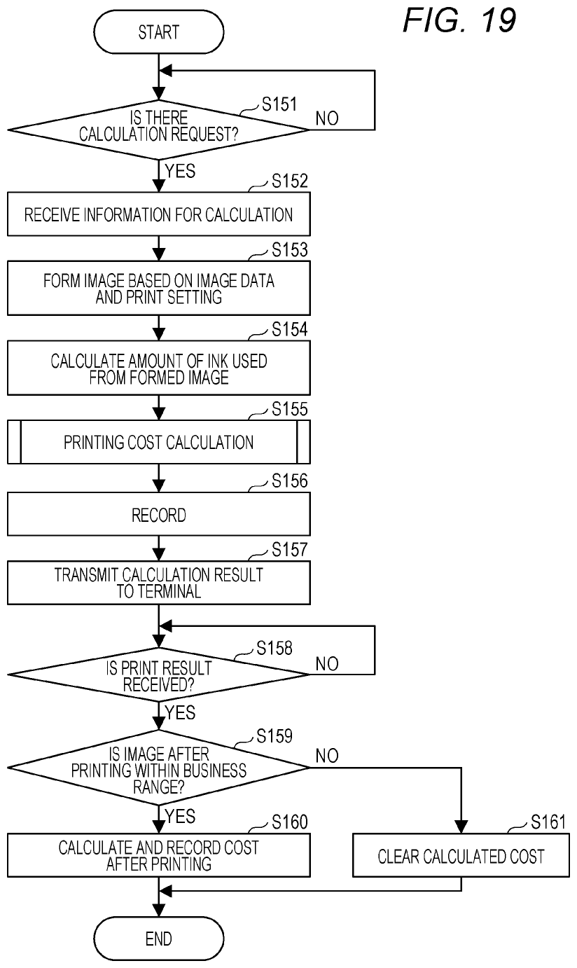

FIG. 19 is a flowchart illustrating the operation of the printing cost calculation apparatus 3 according to other embodiments of the present invention. In such embodiments, it is determined whether or not an image after printing is within a business range, and thus it is determined whether or not the image is a charging target. If the image is not a charging target, the calculated printing cost is cancelled or cleared (not charged to the business).

Referring to FIG. 19, since the operations in steps S151 to S158 are the same as those in steps S131 to S138 in FIG. 18, a description thereof will be omitted.

In step S159, it is determined whether or not the image after the printing included in the calculation information received in step S158 is within the business range. Whether or not the image is within the business range is determined by checking whether or not the image has a pre-registered character, pattern, watermark, or the like indicating that the image is within the business range, as in step S34 in the flowchart of FIG. 8 described above. If the image has such information, it is determined that the image is within the business range. Alternatively, whether the printing is for business use may be determined based on whether a character such as a company name is present in a header or a footer or based on a transmission destination or a reception destination of e-mail.

If the image after printing is within the business range (YES in step S159), it is determined in step S160 that the image is a charging target, and the cost after printing is calculated and recorded. If the image after the printing is not within the business range (NO in step S159), it is determined in step S161 that the image is not a charging target, and the calculated printing cost is cleared (canceled).

As described above, the printing cost is paid only in a case where the image after the printing is within the business range. This prevents a cost from being paid for printing for personal use.

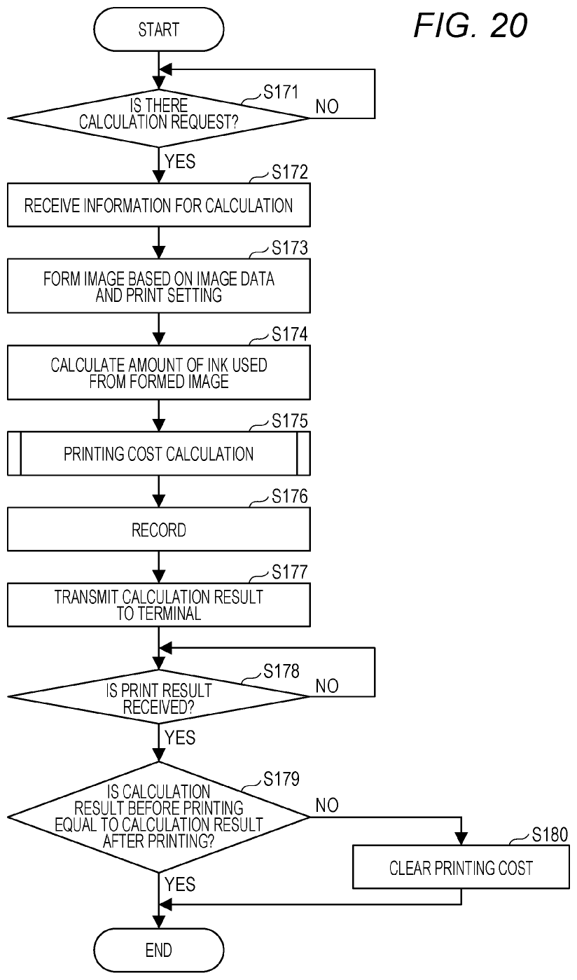

FIG. 20 is a flowchart illustrating the operation of the printing cost calculation apparatus 3 according to other embodiments of the present invention. In such embodiments, images before and after printing are compared to check whether they are the same. If the images are different, the calculated printing cost is cleared.

Referring to FIG. 20, the operations in steps S171 to S178 are the same as those in steps S131 to S138 of FIG. 18, and hence a description thereof is omitted.

In step S179, it is determined whether the image before the printing and the image after the printing are the same by comparing those with each other. If they are the same based on a comparison result (YES in step S179), it is determined that the image is a charging target, and nothing is done. Therefore, in this case, the calculated printing cost is paid. In contrast to this, if the images before and after the printing are not the same based on the comparison result (NO in step S159), it is determined in step S180 that the image is not a charging target, and the printing cost is cleared (cancelled).

As described above, in some embodiments, only in a case where the images before and after the printing are the same, the image is a target for payment of a printing cost. This prevents a print target file from being intentionally changed to make fraudulent charging after the 5 transmission of information for calculation of a printing cost.

When one embodiment of the present invention has been described above, the present invention is not limited to the above-described embodiment. For example, the embodiments may not be independent of each other, and two or more of the embodiments may be combined.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

What is claimed is:

1. A printing cost calculation system comprising:
a terminal apparatus that comprises a hardware processor and instructs an image forming apparatus to perform printing; and
a printing cost calculation apparatus that comprises a hardware processor and communicates with the terminal apparatus, wherein
the hardware processor of the terminal apparatus transmits, to the printing cost calculation apparatus, calculation information that is necessary for calculating a printing cost and includes information unique to the image forming apparatus, and
the hardware processor of the printing cost calculation apparatus:
calculates the printing cost based on the calculation information transmitted from the terminal apparatus, and
outputs a calculation result of the printing cost.

2. The printing cost calculation system according to claim 1, wherein
the hardware processor of the terminal apparatus:
determines whether to charge for the printing cost, and
transmits, to the printing cost calculation apparatus, the calculation information only when determining to charge for the printing cost.

3. The printing cost calculation system according to claim 2, wherein the hardware processor of the terminal apparatus determines whether to charge for the printing cost using image information of a printing target file.

4. The printing cost calculation system according to claim 2, wherein the hardware processor of the terminal apparatus determines whether to charge for the printing cost using attached information of a printing target file.

5. The printing cost calculation system according to claim 2, wherein the hardware processor of the terminal apparatus determines whether to charge for the printing cost using time information.

6. The printing cost calculation system according to claim 1, wherein the information unique to the image forming apparatus is product information on at least one of the image forming apparatus and a consumable of the image forming apparatus.

7. The printing cost calculation system according to claim 1, wherein the information unique to the image forming apparatus is unit price information of a consumable of the image forming apparatus.

8. The printing cost calculation system according to claim 1, further comprising:
a cost settlement device that pays the printing cost calculated by the printing cost calculation apparatus to a user of the terminal apparatus.

9. The printing cost calculation system according to claim 1, wherein
the hardware processor of the printing cost calculation apparatus:
determines whether to permit payment for the printing cost, and
notifies the terminal apparatus of a determination result.

10. The printing cost calculation system according to claim 9, wherein the hardware processor of the printing cost calculation apparatus determines whether to permit payment for the printing cost by comparing the printing cost with an upper limit value of the printing cost allocated in advance to the user as an individual or to a group of the user.

11. The printing cost calculation system according to claim 9, wherein the hardware processor of the printing cost calculation apparatus determines whether to permit the payment depending on whether the printing is necessary for business.

12. The printing cost calculation system according to claim 11, wherein the hardware processor of the printing cost calculation apparatus determines whether the printing is necessary for business using image information of a printing target file.

13. The printing cost calculation system according to claim 11, wherein the hardware processor of the printing cost calculation apparatus determines whether the printing is necessary for business using attached information of a printing target file.

14. The printing cost calculation system according to claim 11, wherein the hardware processor of the printing cost calculation apparatus determines whether the printing is necessary for business based on time information.

15. The printing cost calculation system according to claim 1, wherein
in a case that the terminal apparatus transmits calculation information before printing and calculation information after the printing, the hardware processor of the printing cost calculation apparatus:
calculates the printing cost upon each reception of calculation information before and after the printing, and
when determining that the printing cost before the printing and the printing cost after the printing are not identical, updates the printing cost calculated based on the calculation information before the printing to the printing cost calculated based on the calculation information after the printing.

16. The printing cost calculation system according to claim 15, wherein
the hardware processor of the printing cost calculation apparatus:
determines whether the printing cost is not a charging target after reception of the calculation information after the printing, and
when determining that the printing cost is not a charging target, clears the calculated printing cost.

17. The printing cost calculation system according to claim 16, wherein the hardware processor of the printing cost calculation apparatus determines whether the printing cost is not a charging target using a comparison result between image data before the printing and image data after the printing.

18. A printing cost calculation method executed by a printing cost calculation system comprising a terminal apparatus that instructs an image forming apparatus to perform printing and a printing cost calculation apparatus that communicates with the terminal apparatus, the method comprising:
causing the terminal apparatus to transmit, to the printing cost calculation apparatus, calculation information that is necessary for calculating a printing cost and includes information unique to the image forming apparatus; and
causing the printing cost calculation apparatus to calculate the printing cost based on the calculation information transmitted from the terminal apparatus and output a calculation result of the printing cost.

19. A printing cost calculation apparatus communicating with a terminal apparatus that instructs an image forming apparatus to perform printing, the printing cost calculation apparatus comprising:
a hardware processor that:
receives, from the terminal apparatus, calculation information that is necessary for calculating a printing cost and includes information unique to the image forming apparatus;
calculates the printing cost based on the calculation information; and
outputs a calculation result of the printing cost.

20. A terminal apparatus that instructs an image forming apparatus to perform printing and communicates with the printing cost calculation apparatus according to claim 19, the terminal apparatus comprising:
a hardware processor that transmits, to the printing cost calculation apparatus, calculation information that is necessary for calculating a printing cost and includes information unique to the image forming apparatus.

21. A non-transitory computer readable recording medium storing instructions for causing a computer of the printing cost calculation apparatus according to claim 19 communicating with a terminal apparatus that instructs an image forming apparatus to perform printing, to execute:
receiving, from the terminal apparatus, calculation information that is necessary for calculating a printing cost and includes information unique to the image forming apparatus;
calculating the printing cost based on the calculation information received in the receiving; and
outputting a calculation result of the printing cost calculated in the calculating.

22. A non-transitory computer readable recording medium storing instructions for causing a computer of a terminal apparatus that instructs an image forming apparatus to perform printing and communicates with the printing cost calculation apparatus according to claim 19 that calculates a printing cost in the image forming apparatus, to execute:
transmitting, to the printing cost calculation apparatus, calculation information that is necessary for calculating the printing cost and includes information unique to the image forming apparatus.
